(19) United States
(12) Patent Application Publication
(10) Pub. No.: US 2012/0068519 A1
(43) Pub. Date: Mar. 22, 2012

(54) VEHICLE SEAT CUSHION

(75) Inventors: Jean-Christophe Lhommeau, Krautergersheim (FR); Antolne Fluhr, Griesheim-sur Souffel (FR); Patrick Rutter, Ostwald (FR); Horst Steinmeier, lubbecke (DE); Laurent Hugues, Soultz les bains (FR); Bernhard Riezler, Altenmarkt im Pongau (AT)

(73) Assignee: JOHNSON CONTROL TECHNOLOGY COMPANY

(21) Appl. No.: 13/254,436

(22) PCT Filed: Mar. 9, 2010
(86) PCT No.: PCT/EP2010/001456

§ 371 Date: Dec. 5, 2011

(30) Foreign Application Priority Data
Mar. 9, 2009 (DE) 10 2009 011 736.9

(51) Int. Cl. B60N 2/44; B68G 15/00; B68G 7/00

(52) U.S. Cl. 297/452.48; 29/91.1; 29/91.7

(57) ABSTRACT

A vehicle seat cushion comprises at least two foam materials, having different hardnesses, and a fleece arranged between the foam materials. The cushion may be made by introducing a first material into a tool, covering the first material with the fleece, and then introducing a second material into the tool. Alternatively, both materials, separated by the fleece, may be introduced into the tool. The foam materials may have the same or different thicknesses, and these thicknesses may vary over the length and/or width of the cushion.

### BACKGROUND

The present invention relates to a vehicle seat cushion consisting of at least two foam materials each having a different hardness. Furthermore, the present invention relates to a process and a tool for producing such a seat cushion.

At present, vehicle seats have cushions which are arranged both in the so-called seat part and in the backrest. These cushions serve both for affording the occupant of the seat the most secure position possible in the vehicle seat and for increasing the comfort of the seat. For this reason, provision is often made of vehicle seat cushions consisting of at least two foam materials each having a different hardness, in which case the foam material located closer to the occupant of the vehicle generally has a lower hardness than the foam material located further away from the occupant of the vehicle.

In the past, the foam materials were generally adhesively bonded to one another, which is time-consuming, involves a large amount of material and requires a finishing process. The production of such vehicle seat cushions was accordingly relatively complex in the past.

It was therefore the object of the present invention to provide a vehicle seat cushion which can be produced more easily and more cost-effectively. It was a further object of the present invention to provide a process and a tool with which a vehicle seat cushion consisting of at least two foam materials each having a different hardness can be produced more easily.

### SUMMARY

The object is achieved by a vehicle seat cushion consisting of at least two foam materials each having a different hardness, wherein a fleece is arranged between the foam materials.

The present invention relates to a vehicle seat cushion which can be provided in the seat part and/or in the backrest of a vehicle seat. Such a vehicle seat, which can be arranged in any desired means of transport, affords space to one or more people. The vehicle seat according to the invention can accordingly also be a bench seat. This vehicle seat cushion comprises at least two foam materials each having a different hardness, i.e. in which the force or the pressure required for a specific deformation of the respective foam material is different. The orientation of the interface of the two foam materials and therefore of the fleece is preferably in each case substantially the same as the orientation of the vehicle cushion, i.e. substantially horizontal in the seat region and substantially vertical in the backrest region. The softer foam material will generally be arranged closer to the occupant of the vehicle than the harder foam material. The softer foam material generally serves, in particular, for increasing the comfort for the occupant of the vehicle, whereas the harder foam material serves, in particular, for stabilizing the position in the seat and/or for avoiding injuries, for example in the event of an accident.

Suitable foam materials are all foam materials familiar to a person skilled in the art. The foam materials of the vehicle seat cushion can be produced from the same or different materials, with different materials generally being preferred. The two foams are, however, preferably polyurethane foams, although it is preferable for the starting components for the polymerization to be different.

According to the invention, a fleece is arranged between the two foam materials and preferably extends over the entire interface between the softer and the harder foam material. The fleece is preferably produced from a polymeric material, in particular polyethylene and/or polypropylene.

In a further preferred embodiment, the fleece is a fabric, in particular a polymeric fabric. Here, it is particularly preferable for the structure of the fabric to be selected such that the two polymeric materials intermingle in the liquid state, if at all, only to a very small extent. However, the fabric is particularly preferably provided such that it can be permeated at least partially by at least one of the liquid polymeric materials, and therefore an integral bond is established with very particular preference with at least one of the foam materials, preferably with both of the foam materials.

The thickness of the softer foam material is preferably at least 5 mm, particularly preferably >100 mm.

In a further preferred embodiment, the thickness of the harder foam material is at least 5 mm, particularly preferably >100 mm.

Furthermore, it is preferable that the thickness of the softer and/or of the harder foam material is not constant over the width and/or over the length of the seat cushion, but instead varies according to the respective local requirements in terms of comfort and sitting stability.

Furthermore, the object is achieved by a process for producing the seat cushion as claimed in one of the preceding claims, in which a first liquid foam material is introduced into a tool, this foam material is covered with a fleece, a second liquid foam material is introduced into the tool and both foam materials set at least partially at the same time in the tool.

In the process according to the invention, firstly a first liquid foam material is introduced into a tool and is then covered with the fleece, such that one of the two surfaces preferably comes into contact with the first liquid foam material. A second liquid foam material is then applied to the second surface of the fleece, and then the two liquid foam materials set in the tool. Here, an integral bond is preferably established between at least one of the two foam materials and the fleece and/or between the two foam materials. It is preferable for first the softer foam material and then the harder foam material to be introduced into the tool.

However, it is also possible to introduce the two foam materials at least partially at the same time into the tool, with the fleece keeping the liquid foam materials at least substantially separated from one another. After the two foam materials have been introduced, they set at least partially at the same time.

The processes according to the invention have the advantage that both foam materials set at the same time without inadmissible intermingling. As a result, the time required to produce the seat cushion according to the invention can be reduced considerably, preferably halved.

The fleece is preferably provided on a frame, in particular tensioned on a frame. This frame is preferably provided so as to be movable, particularly preferably rotationally or pivotably movable, and is lowered onto the first foam material once the latter has been introduced into the tool, for example, before the frame is covered by a second tool part, which is then filled with the second foam material.

The object is furthermore achieved by a tool for producing a vehicle seat cushion as claimed in one of the preceding claims, wherein it has a lower part, an upper part and a frame, which is arranged between said parts and holds the fleece.

All of the statements made above similarly apply to all the subjects of the invention.

### DRAWINGS

The text which follows explains the inventions on the basis of FIGS. 1 to 3. These explanations are given purely by way of example and do not limit the general concept of the invention. The statements made similarly apply to all the subjects of the invention.

FIG. 1 shows the vehicle seat cushion according to the invention.

FIGS. 2 and 3 show the tool according to the invention.

### DETAILED DESCRIPTION

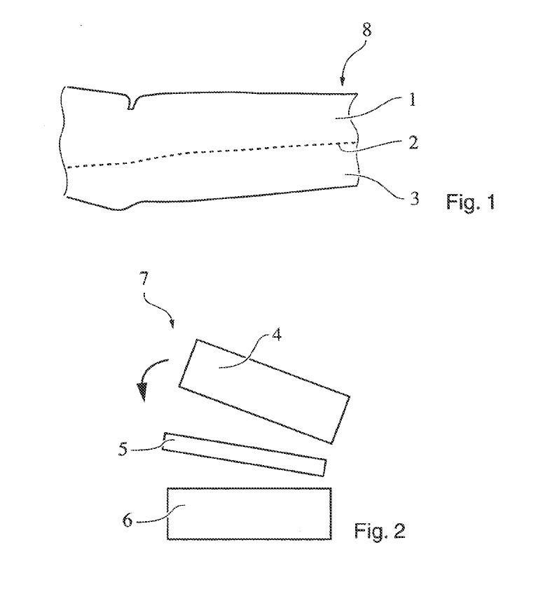

FIG. 1 shows a section of the vehicle seat cushion used for the seat part of the vehicle seat. The lower region of this vehicle seat cushion is provided with a layer comprising a relatively hard foam 3, and the upper region thereof is provided with a layer comprising a relatively soft foam material 1. The two foam materials 1, 3 are separated by a fleece 2. The two layers have substantially the same orientation as the contour of the seat cushion, i.e. here they run substantially horizontally. Accordingly, the fleece is also oriented substantially horizontally here. In the case of a seat cushion for the backrest, the layers and the fleece run substantially vertically. It can clearly be seen that the thickness both of the foam material 1 and of the foam material 3 varies over the extent of the seat cushion. In the present case, the two foam materials are a polyurethane foam, which is produced on the basis of MDI or TDI. The foams have a density of between 30 and 90 g/l. The softer foam material preferably has a hardness of between 3 and 20 kPas (40%, 4 cycles) and the harder foam material preferably has a hardness of 3 to 20 kPas (40%, 4 cycles).

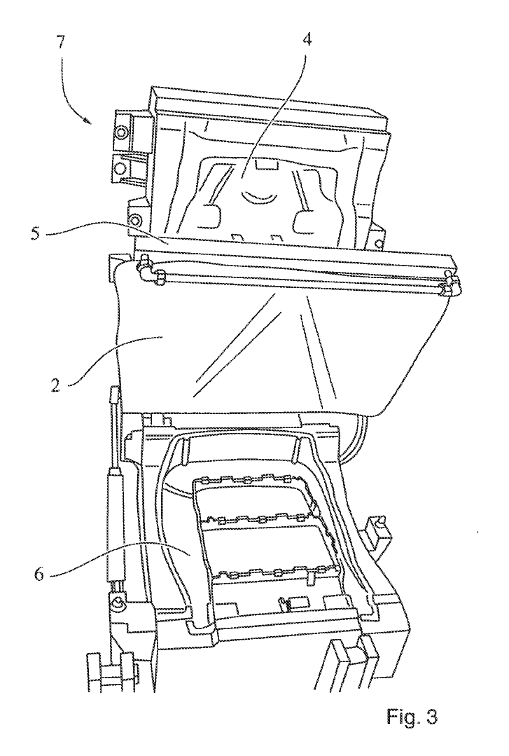

FIGS. 2 and 3 show the tool according to the invention, consisting of a lower tool 6, an upper tool 4 and also a frame 5. The tools 4, 6 each provide the mold for one of the foam materials 1, 3, whereas the frame 5 serves to receive the fleece. Both the frame 5 and the upper tool 4 are provided so as to be movable, in particular rotationally movable, in the present case. After the lower part 6 of the tool has been filled with a first liquid foam material, preferably the softer foam material, the frame 5, on which the fleece is provided, is lowered onto the lower part 6, such that the fleece preferably touches the liquid foam material in the lower tool 6. Then, the upper part 4 is lowered onto the frame 5, and the tool is thereby at least mostly sealed. Beforehand, at the same time and/or subsequently, the second liquid foam material, preferably the harder foam material, is introduced into the tool. Both foam materials then set at least partially, preferably completely, substantially at the same time, before the tool is reopened and the, then finished, vehicle seat cushion according to the invention can be removed from the mold. The tool is then available for producing a further seat cushion.

### LIST OF REFERENCE SYMBOLS

Soft foam material

Fleece

Hard foam material

Upper part of the tool

Frame

Lower part of the tool

Tool

Cushion

1. A vehicle seat cushion comprising at least two foam materials having different hardnesses, wherein a fleece is arranged between the foam materials.

2. The vehicle seat cushion as claimed in claim 1, wherein the fleece comprises a polymeric material.

3. The vehicle seat cushion as claimed in claim 1, wherein the fleece enters into an integral bond with at least one of the foam materials.

4. The vehicle seat cushion as claimed in claim 1, wherein the thickness of a softer of the foam materials is at least 5 mm.

5. The vehicle seat cushion as claimed in claim 1, wherein the thickness of a harder of the foam materials is at least 5 mm.

6. The vehicle seat cushion as claimed in claim 1, wherein the thickness of a softer of the foam materials varies over the length and/or width of the seat cushion.

7. A process for producing a seat cushion comprising introducing a first liquid foam material into a tool, covering the foam material with a fleece, introducing a second liquid foam material into the tool, and allowing both foam materials set at least partially uniformly in the tool.

8. A process for producing a seat cushion comprising introducing a first and a second liquid foam material separated from one another substantially by a fleece into a tool, and allowing both foam materials set at least partially at the same time in the tool.

9. The process as claimed in claim 7, wherein the fleece is provided on frame.

10. A tool for producing a vehicle seat cushion as claimed in claim 1, comprising a lower part, an upper part, and a frame arranged between said parts and holds the fleece.

11. The vehicle seat cushion as claimed in claim 1, wherein the fleece comprises a polymeric fabric.

12. The vehicle seat cushion as claimed in claim 1, wherein the fleece enters into an integral bond with both of the foam materials.

13. The vehicle seat cushion as claimed in claim 1, wherein the thickness of a harder of the foam materials varies over the length and/or width of the seat cushion.

14. The vehicle seat cushion as claimed in claim 1, wherein both the thicknesses of both foam materials varies over the length and/or width of the seat cushion.

15. The process as clamed in claim 8, wherein the fleece is provided on a frame.

16. The process as claimed in claim 9, wherein the frame is movable.

17. The process as claimed in claim 15, wherein the frame is movable.
